(19) United States
(12) Patent Application Publication
(10) Pub. No.: US 2012/0143968 A1
(43) Pub. Date: Jun. 7, 2012

(54) SYSTEMS AND METHODS FOR TERMINATING COMMUNICATIONS BETWEEN REGISTERED MEMBERS OF A COMMUNICATIONS SERVICE

(76) Inventors: Amichay OREN, Rosh-a-ayin (IL); Gregory Alan Hardy, Marietta, GA (US); Michael South, Jackson, NJ (US); John Erickson, Freehold, NJ (US)

(21) Appl. No.: 13/197,571

(22) Filed: Aug. 3, 2011

Related U.S. Application Data
(60) Provisional application No. 61/370,437, filed on Aug. 3, 2010.

(51) Int. Cl. G06F 15/16

(52) U.S. Cl. 709/206

(57) ABSTRACT

Systems and methods for establishing a communications channel between a first user and a second user through a first communications system make use of contact information obtained from a second communications system. The contact information obtained from the second communications system is stored in a cross-reference database maintained on the first communications system. The information could be obtained by having the first communications system access the second communications system using the credentials of a user of the second communications system to obtain contact information stored on the second communications system for the user. The information in the cross-reference database allows the first communications system to determine a non-publically switched telephony network (PSTN) identifier of a telephony device associated with the second user. This identifier is then used to establish a communications channel between the first user and the second user.

This application claims priority to U.S. Provisional Application No. 61/370,437 filed Aug. 3, 2010, the entire contents of which are hereby incorporated by reference.

### BACKGROUND OF THE INVENTION

Social networking sites, such as Facebook and MySpace, allow users to post information about themselves, photos, videos and other information to a centrally available location. Once registered, users are able to view information, photos, videos and other information posted by other registered users. Most social networking sites also allow users to create contact or “friend” lists. People on a first user's contact or friend list are granted the ability to view the information posted by the first user.

In addition, many social networking sites provide users with the ability to easily exchange written messages, similar to the exchange of email communications, between themselves and other registered users that are on their contact or friend list. Further, many social networking sites allow registered users to establish instant messaging sessions with others on their contact or friend list. Once an instant messaging session is established, two users can rapidly exchange text messages back and forth.

Although many social networking sites allow a user to build a list of contacts or friends, the information recorded by the social networking site for each contact or friend typically does not include telephone numbers of the people on the contact/friend list. As a result, if a first registered user wishes to make a telephone call to one of the people on his contact or friend list, the user must independently know the telephone number to call to reach that person.

Likewise, if a first registered user wishes to establish an instant messaging session with a second registered user who is one of the people listed on the first user's contact or friend list, the instant messaging session must be established through the social networking site while both parties are actively logged into the social networking site. Unfortunately, it is often impossible for a first user to establish an instant messaging session with the second user because the second user is not logged onto the social networking site.

### BRIEF DESCRIPTION OF THE DRAWINGS

FIG. 1 is a block diagram of elements of a system which can be used to facilitate communications between registered users of a communications service;

FIG. 2 illustrates a table that cross-references user credentials to other unique identifiers, such as unique identifiers assigned by one or more social networking sites;

FIG. 3 shows a table that cross-references user credentials to Internet Protocol (IP) addresses of user devices;

FIG. 4 is a flow diagram illustrating steps of a method of registering a user with a communications system that facilitates communications between registered users;

FIG. 5 illustrates a typical user interface screen which would be viewed by a user of a communications system that facilitates communications between registered users; and

FIG. 6 is a flow diagram illustrating steps of a method that allows communications to be exchanged between registered users of a communications system.

### DETAILED DESCRIPTION OF THE INVENTION

The following description will refer to “social networking sites.” This term is intended to cover any social networking service, such as MySpace, Facebook, LinkedIn and others that allow registered users to establish contact with one another. Such services typically allow users to easily exchange information with one another. Such services may also facilitate communications that pass back and forth between the users.

As is well known to those of ordinary skill in the art, users typically access social networking sites via an Internet connection using a computer. Also, many social networking sites provide specialized software that allows users to easily access the information and services offered by the social networking site via a smart phone, a mobile communications device, or another portable handheld interface device.

Different social networking sites refer to a user's known contacts in different ways. Some social networking sites call the user's list of contacts a contact list. Other social networking sites call it a friend list. Regardless of the name used by the social networking site, the following description will use the term “contact list” to refer to any list of contacts, friends, or other networked individuals with whom a user has established an acknowledged relationship via a social networking site.

The following description will also refer to “mobile devices,” “telephony devices,” and “communications devices.” These terms are intended to include any devices that enable users to exchange audio, visual and/or text based communications with others. This could include normal analog telephones, Internet Protocol (IP) adapters that are used to interface an analog telephone to an IP based communications network, IP telephones, a computer or computing device running software that allows the computer or computing device to act like an IP telephone, smart phones such as the Apple iPhone and other similar devices, and other communications devices that exchange text and/or audio messages via digital data such as the Apple iTouch and the Apple iPad.

The systems and methods described herein allow a first registered user of a social networking site to easily establish a voice communications link between the first user's mobile or telephony device and a mobile or telephony device owned or used by a second registered user of the social networking site. Typically, the second user would be someone listed on the first user's contact list within the social networking site. Because of the way the systems and methods are structured, there is no need for the first user to know a telephone number associated with the second user's telephony or mobile device.

Likewise, the systems and methods described herein allow a first registered user of a social networking site to easily establish an instant messaging session with a second registered user of the social networking site, and the instant messaging session can be established outside of the social networking site. As a result, there is no need for both users to be actively logged onto the social networking site when the instant messaging session is established. And because of the way the systems and methods are structured, there is no need for the first user to know any unique information about the second user in order to establish the instant messaging session. All information needed to establish an instant messaging session between the first and second users is obtained by the systems and methods described herein from information available on the social networking site and/or obtained during an initial registration process.

In the following description, an initial registration process will first be described. During the registration process, a user will register for a communications service that facilitates communications between registered users of the service. After the registration process has been described, the systems and methods performed by the new communications service to facilitate communications between registered users will be described.

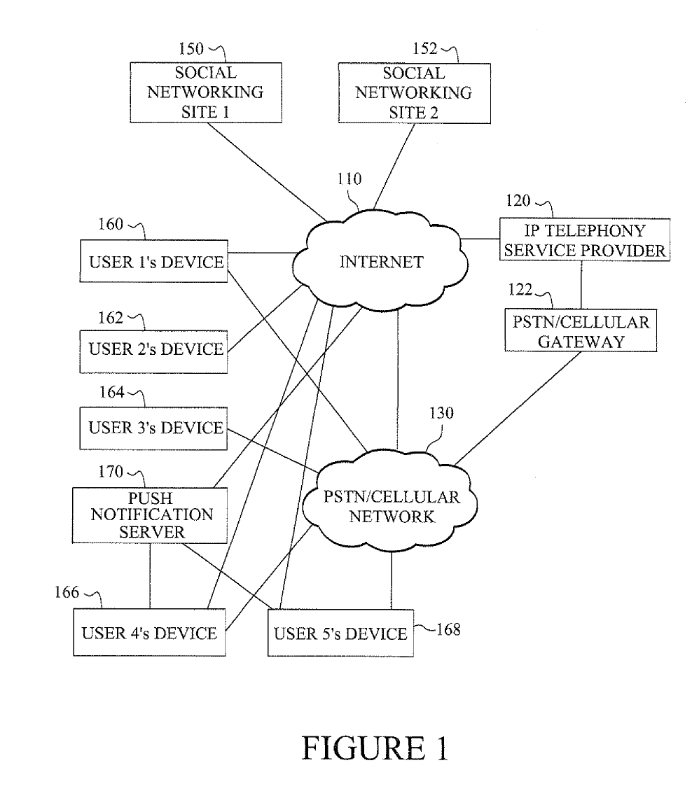

FIG. 1 illustrates the elements of a system which could be used to facilitate communications between registered users of a social networking site. As shown in FIG. 1, multiple user devices 160, 162, 164, 166, 168 are connected to the Internet 110 and/or to a publicly switched telephone network (PSTN) and/or to a cellular telephone network 130. Each user device could be any of the mobile or telephony devices described above. Some of these user devices, such as User 1's device 160, User 4's device 166 and User 5's device 168 are capable of communicating via both digital data communications passing over the Internet 110 and via a cellular telephone network 130. These devices could be smart phones, such as the Apple iPhone or similar devices.

Other user devices, such as User 2's device 162, are only capable of communicating via a digital data connection to the Internet 110. Examples of such devices include the Apple iTouch and an Apple iPad lacking a cellular communications capability.

Still other mobile devices, such as User 3's device 164, might only be capable of communicating via the PSTN and/or the cellular telephone network 130. Such devices might only be capable of communicating via the PSTN. In other instances, such devices might only be capable of communicating via a cellular telephone network. In still other instances, the device might be capable of establishing separate voice and data connections via a cellular telephone network 130.

FIG. 1 also illustrates two social networking sites 150, 152 which are also accessible via the Internet 110. As noted above, users can log on to a social networking site 150, 152 via a computer connected to the Internet 110. Alternatively, users may be able to access a social networking site 150, 152 using a mobile or telephony device 160, 162, 164, 166, 168. Communications between the user devices and the social networking sites 150, 152 could be implemented via digital data packets that traverse the Internet 110. In other instances, communications between the user devices and the social networking sites could pass first from a user device to a cellular telephone service provider via a cellular data channel. The cellular service provider 130 could then pass that data to the social networking sites 150, 152 either directly, or through the Internet 110.

FIG. 1 also illustrates the use of a push notification server 170. Some mobile and telephony devices are configured to enter a dormant mode, to conserve power, if no data communications are received for a certain period of time. When such a device is in a dormant mode, the device will not normally receive data communications sent over the Internet, or over a data channel of a cellular telephone service. More specifically, when the mobile device is in the dormant mode, the device will not have an established IP address. And because the device does not have an IP address, it is impossible for a computer or server to address data packets to the mobile device. However, it is possible to “wake up” the device by sending a SMS message to the device.

Basically, when it is necessary to send a data communication to a mobile device that is dormant, a data communication is first sent to the push notification server 170. The push notification server 170 then sends a SMS message to the device to cause the device to wake up, and to re-acquire an IP address. The new IP address is then sent to the push notification server 170, and the push notification server forwards that IP address on to the computer or server that originally requested that the mobile device be woken up. Data communications can then be sent to the device via the Internet 110 or via a data channel of the cellular telephone network 130.

As illustrated in FIG. 1, User 4's device 166 and User 5's device 168 operate in this fashion and receive wake up communications from the push notification server 170. Examples of such devices include the Apple iPhone.

FIG. 1 also illustrates an Internet Protocol (IP) telephony service provider 120. The IP telephony service provider 120 is connected to the Internet 110. The IP telephony service provider 120 is also able to communicate with the PSTN/cellular network 130 via a PSTN/cellular gateway 122.

A new communications service for facilitating communications between registered users could be provided by the IP telephony service provider 120. However, in order for the IP telephony service provider to implement this service, it is first necessary for individual users of the new service to complete a registration process that allows the IP telephony service provider 120 to acquire key information necessary to implement the new communications service.

During the registration process, the IP telephony service provider acquires key information that allows the IP telephony service provider to cross-reference a unique master identifier assigned to each user against one or more other identifiers that are also associated with the user. This information is compiled in an ID cross-reference table.

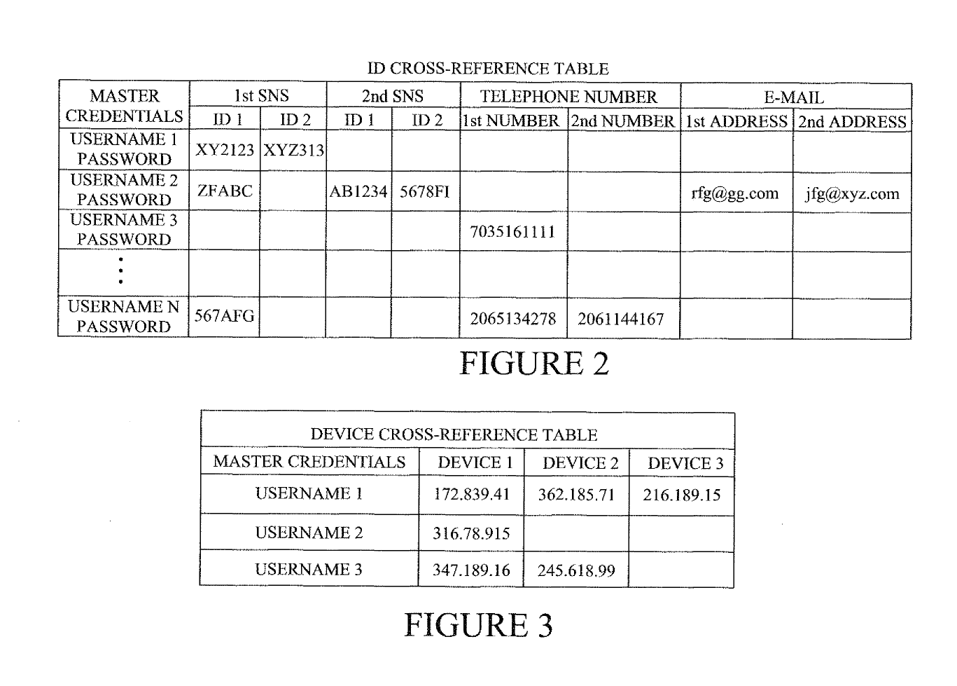

FIG. 2 shows one example of an ID cross-reference table that would be maintained by the IP telephony service. In this embodiment, master user credentials are cross-referenced with or to other identifiers associated with the user. In some embodiments, the master user credentials could be Session Initiation Protocol (SIP) credentials in the form of a username and password. In other embodiments, other information could be used as the master user credentials.

Each user's master credentials could be cross-referenced to unique identifiers assigned to the user by one or more social networking sites. In addition, a user's master credentials could also be cross-referenced to one or more telephone numbers associated with the user. Further, a user's master credentials could also be cross-referenced to one or more e-mail addresses. In some embodiments, a user's master credentials could also be cross-referenced to other unique identifiers that also facilitate routing communications to and from the user, the above items are only intended to be exemplary.

For instance, the table illustrated in FIG. 2 shows that User 1 has master user credentials which are cross-referenced to first and second identifiers assigned by a first social networking site. This means that the user has established two identities on the first social networking site, and each identity was assigned a different unique identifier by the first social networking site.

User 2 has master user credentials that are cross-referenced to a single unique identifier on the first social networking site, and to two unique identifiers on a second social networking site. In addition, the User 2's master credentials are also cross-referenced to two e-mail addresses.

User 3 has master user credentials that are cross-referenced to a single telephone number.

The table would include all registered users of the communications service. The way in which the ID cross-reference table is used to facilitate communications is discussed in more detail below.

The IP telephony service provider 120 also cross references each user's master credentials to device registration data associated with each of the user's devices, such as IP addresses and port information. A device cross-reference table with this information is illustrated in FIG. 3. The device registration data for each communications device maintained by a user is listed against the user's master credentials. And this device registration data can be used to route communications to the user.

In the example illustrated in FIG. 3, the master user credentials for username 1 are cross-referenced to device registration data for three communications devices. The device registration data could be the IP address assigned to User 1's mobile telephone, the IP address assigned to User 1's IP telephone in the user's residence, and the IP address assigned to a softphone client resident on User 1's computer.

FIG. 3 also illustrates that User 2's master credentials are cross-referenced to device registration data for only a single communications device, and that User 3's master credentials are cross-referenced to device registration data for two communications devices.

A table as illustrated in FIG. 3 would need to be constantly updated as many IP based devices will periodically change their assigned registration data. Also, as mentioned above, some devices such as the Apple iPhone are designed to go into a dormant state, at which point they release any assigned IP address. Thus, such devices will spend periods of time when no IP address is assigned to the device. When a push notification server acts to re-activate the device, a new IP address will be assigned, and it will then be necessary to update the cross-reference table with the new IP address.

As an example, assume that a registered user of a social networking site decides to register with the communications service offered by the IP telephony service provider. During the registration process, the user may be asked to interact with the social networking site in various ways to inform the social networking site that the IP telephony service provider is authorized to obtain and use information about the user that is maintained on the social networking site. In some embodiments, this may result in the social networking site providing the IP telephony service provider with a token or code that can be used to obtain information about the user from the social networking site, or to periodically obtain updated information from the social networking site.

Once this authorization has been arranged, the IP telephony service provider 120 obtains information about the user, or information from the user's account with the social networking site. For instance, the IP telephony service provider 120 could obtain one or more unique identifiers that were assigned to the user by the social networking site. The IP telephony service provider could also obtain the user's contact list from the social networking site. The contact list could be provided in the form of a list of individual unique user identifiers that have been assigned by the social networking site to each of the individuals listed on the user's contact list.

If the new user already has an account with the IP telephony service provider 120, the IP telephony service provider 120 might already have established master user credentials for the user. If so, any unique identifiers assigned to the user by the social networking site would be cross-referenced to the user's master credentials in a table like the one illustrated in FIG. 2. If not, the IP telephony service provider would establish master user credentials for the user, and those master credentials would be cross-referenced to any unique identifiers assigned by the social networking site.

In some embodiments, during the registration process the IP telephony service provider might review any contact information stored in the device that the user is operating to accomplish the registration process. The IP telephony service provider might be able to match up telephone numbers, e-mail addresses and other forms of unique identifiers in this contact information with other entries in the ID cross-reference table. If so, the IP telephony service provider might add information to its own ID cross-reference table based on the user's contact information.

In addition, the IP telephony service provider would be able to determine which of the individuals on the user's contact list are also already registered with the communications service. This could be done by matching entries on the user's contact list with entries on the ID cross-reference table using key information items such as telephone numbers and e-mail addresses, along with names and addresses.

Once multiple users have registered for the new communications service, the IP telephony service provider 120 will have cross-referenced each user's master credentials against other unique identifiers assigned to the users. In addition, the IP telephony service provider will be able to determine the device registration data assigned to user devices using a device cross-reference table as illustrated in FIG. 3. As will be explained in more detail below, the information maintained in these tables can be used to facilitate communications between the registered users.

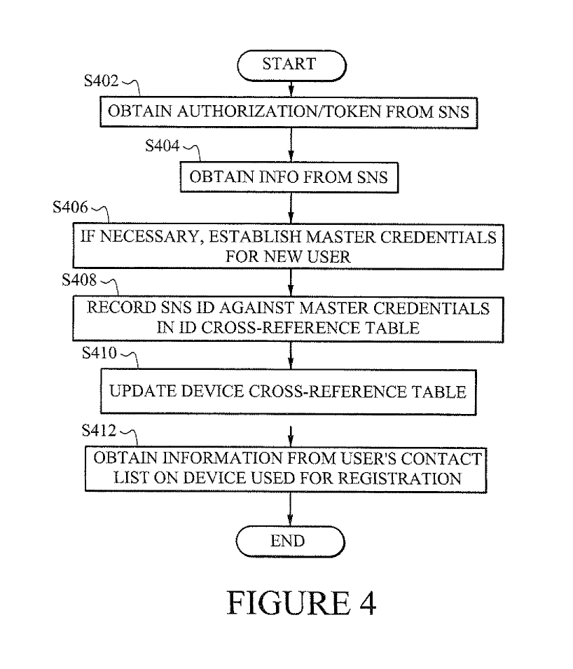

FIG. 4 is a flow chart illustrating steps of a method of registering a new user with a communications service offered by an IP telephony service provider. This method includes obtaining information from a social networking site during the registration process.

As shown in FIG. 4, the method begins in step S402 when a user contacts the IP telephony service provider and asks to register for the communications service. During step S402, the IP telephony service provider obtains authorization to access a social networking site at which the user is registered to obtain information from the social networking site. As explained above, this could include obtaining a token from the social networking site that allows the IP telephony service provider to periodically obtain updated information.

In step S404, the IP telephony service provider then obtains information from the social networking site about the user. As explained above, the information obtained from the social networking site could take a variety of different forms. Primarily, the IP telephony service provider would obtain any unique identifiers assigned to that user by the social networking site. The IP telephony service provider might also obtain that user's contact list. In some instances, the contact list for a user could be a list of the unique identification numbers assigned by the social networking site to the people in the user's contact list. The IP telephony service provider might also obtain from the social networking site a copy of an image or photo that the user has designated to identify himself, as well as photos or images for the people on the user's contact list.

In step S406, the IP telephony service provider determines whether or not the user is already registered with the IP telephony service. If not, the IP telephony service provider establishes master user credentials for the new user.

In step S408, the user's master credentials are associated with or cross-referenced to any unique identifiers assigned to the user by the social networking site in an ID cross-reference table like the one shown in FIG. 2.

In step S410, the IP telephony service provider might also update the device cross-reference table. For instance, if the user did not previously have master credentials, a new entry for the user would be added to the device cross-reference table, and the device registration data of the device that the user is operating to complete the registration process would be cross-referenced to the user's master credentials.

In some embodiments, in step S412, the IP telephony service provider might also obtain information from a contact list stored in the device that the user is operating to complete the registration process. Alternatively, the user might direct the IP telephony service provider to a location where a contact list for the user is available, and the IP telephony service provider would review the information on that contact list to see if it is possible to update its ID cross-reference table. The registration process would then end.

The registration process may also include copying some software onto the user's mobile or telephony device. This could include a full suite of software which will be used to facilitate communications with other registered users of a social networking site. Alternatively, a small amount of communication software could be recorded onto the user's mobile or telephony device, and that software could simply direct the mobile or telephony device to locations on a computer network where other software can be obtained and or run.

When a user desires to make use of the new communication service, the user instructs his communications device to begin running the software for the new service. In one embodiment, the software run on the user's communications device causes the device to present the user with a display which shows all of the user's known contacts who are also registered with the communications service. This can include contacts on lists obtained from one or more social networking sites with whom the user has registered, as well as contacts who the user has listed on one or more communications devices.

One would expect that some of the people in the user's various contact lists will have also registered for the new communications service. However, there will also likely be people on the user's various contact lists that have not registered for the new communications service. The user will only be able to use the communications service to establish communications with those people on the user's contact lists who have also registered with the new communications service, because the information obtained during the registration process is needed to enable the IP telephony service provider to establish a communications link.

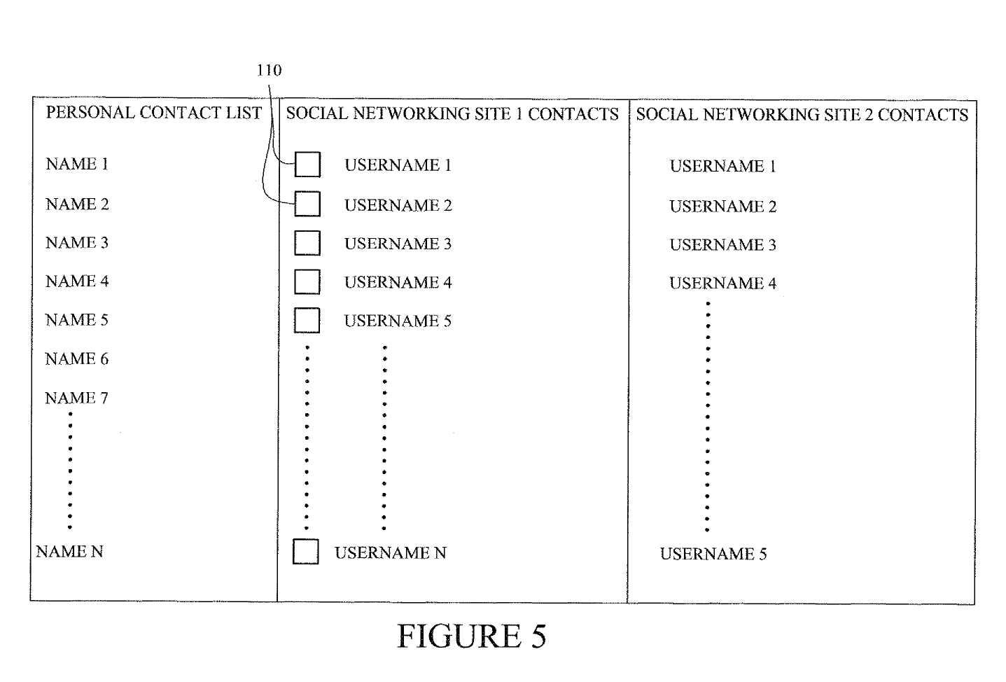

Given all of the above, when a user starts the software to use the new communications service, the software may cause the user's communications device to display one or more lists as illustrated in FIG. 5. In the display illustrated in FIG. 5, three separate columns of contacts are presented to the user. The left-most column shows those individuals who are registered with the service and who were listed on a contact list on the user's communications device.

The center column shows those individuals who are registered with the communications service and who were also on a contact list maintained by a first social networking site with which the user is registered. This column also includes photos or images 110 beside each contact's name. These would be the same images associated with the contacts within the first social networking site. And because these are the same images used by the first social networking site to identify the listed individuals, the images will be familiar to the user.

The right-most column in FIG. 5 shows a list of people who are registered with the communications service and who are also on a contact list maintained for the user by a second social networking site with whom the user is registered. In this column, there are no images beside each name.

In some embodiments, a display as illustrated in FIG. 5 would only include those people who are registered with the communications service. However, in other embodiments the display might include all people listed on a particular contact list that is maintained for or by the user, and the entries would be shaded or otherwise flagged to indicate which of the individuals are registered with the communications service (and thus reachable via the communications service), and which are not. The entries might also be shaded or flagged to indicate whether each of the individuals are currently actively running the communications service software, and which are not.

When the user wishes to establish communications with one of the other registered users, the user could simply select the user name or image associated with one of the registered users on one of the contact lists. This could be done using a cursor and selection key, or by simply touching a touch sensitive display screen. Any other method of selecting a particular user presented on the contact list could also be used to initiate communications with the selected user. Also, the display could include scroll and searching functions to allow the user to quickly and easily locate a particular entry on the contact lists.

In some embodiments, the new communication service would establish a voice communications link between the user's communications device and a communications device for the selected contact. In other instances, the new communication service could establish an instant messaging session between the user and the selected contact. Of course, an embodiment of the new communication service could provide both types of communications.

If the user requests that a voice link be established to the selected contact, the IP telephony service provider would first obtain a unique identifier associated with the selected contact. For instance, if the user selects one of the contacts on the center column of the display illustrated in FIG. 5, the IP telephony service provider might only be provided with a unique identifier for that person that was assigned by the first social networking site. However, this unique identifier from the first social networking site could then be used to obtain that person's master user credentials using an ID cross-reference table as illustrated in FIG. 2.

Using the selected person's master credentials, the IP telephony service provider could then determine the device registration data (such as IP addresses) assigned to the selected person's communications devices using a device cross-reference table like the one illustrated in FIG. 3. And using this device registration data, the IP telephony service provider would establish a voice link with one of the selected person's communications devices. Specifically, the IP telephony service provider could establish an IP telephone call between the user's communications device and one of the selected person's communications devices.

Alternatively, if the user chooses to establish an instant messaging session with the selected contact, the IP telephony service provider would still use the unique identifier assigned by the first social networking site to obtain the selected person's master credentials using an ID cross-reference table as illustrated in FIG. 2. The selected person's master credentials would then be used to obtain the device registration data (such as IP addresses) of one or more of the selected person's communications devices. And this device registration data would be used to establish an instant messaging session with one or more of the selected person's communications devices.

In the methods outlined above, it is possible for a first user to establish a communications link with the second user without knowing a traditional PSTN-convention identifier for the second user's telephony device, such as the telephone number assigned to the second user's telephony device. In some instances, the first user would simply select the second user from a displayed list of contacts. And the telephone number of the second user's telephony device may not be a part of the information stored for the second user in that contact list. In other embodiments, the first user may be able to identify the second user via an e-mail address, or via a username or identifier assigned by a social networking system, and it will still be possible to obtain device registration data for the second user's telephony device so that a communications channel can be established between the first and second users. The use of contact information obtained through a third party social networking systems makes it possible for the first user to contact the second user's telephony device without knowing the telephone number of the second user's telephony device.

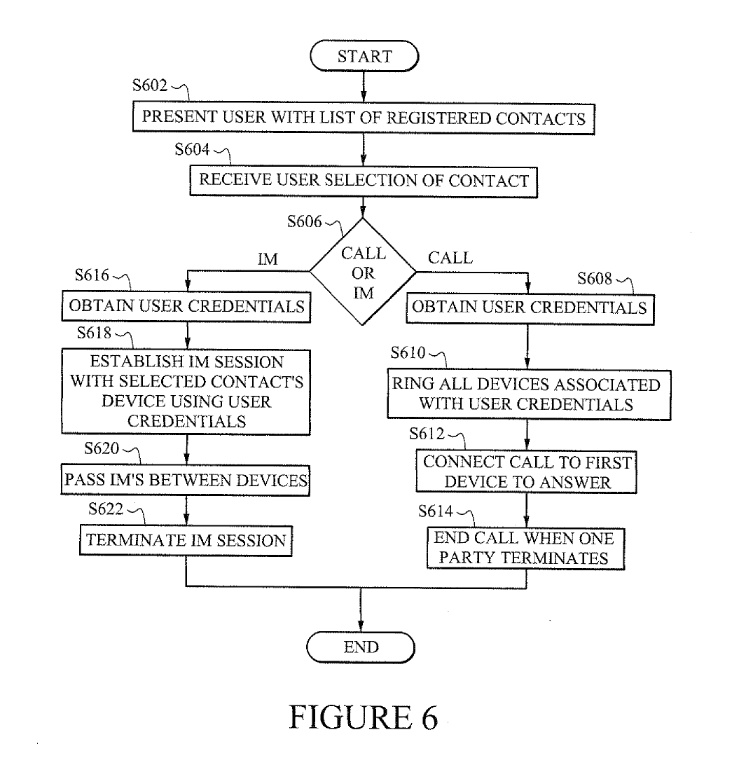

FIG. 6 illustrates steps of a method of establishing communications with another registered member of a social networking site using a new communications service as described above. As shown in FIG. 6, the method starts in step S602 when a user begins running software for the new communications service on his communications device. The software causes the user's communications device to present the user with one or more lists of people drawn from one or more corresponding contact lists that have been created by or for the user. The display presented to the user could include only those individuals that are also registered with the communications service, or both registered and unregistered contacts. The display screen could differentiate between registered and unregistered contacts in various different ways. For instance, registered contacts could appear on one portion of the display, and unregistered contacts could appear on another portion of the display. Alternatively, registered contacts could be shaded or displayed in a particular fashion which is different from unregistered contacts. Also, contacts which are also logged into the new communications service could be identified in a particular fashion.

In step S604, the user selects one of the contacts with whom the user wishes to establish communications. The selection information is then forwarded to the IP telephony service provider.

If both voice communications and instant messaging communications are provided by the new communications service, then in step S606 the user makes a choice to either establish a voice communications link or to initiate an instant messaging session with the selected contact. In other instances, if only one type of communications link is provided by the new communications service, step S606 would be eliminated.

If both types of communications links are provided by the new communications service, and the user selects a voice link, the method proceeds to step S608, and the IP telephony service provider obtains the master user credentials for the selected contact. This could be accomplished using a unique identifier assigned by the social networking site for the selected contact, or based only any other unique identifier for the selected contact that is cross-referenced to the selected contact's master credentials. In some embodiments, when a user selects a contact from a displayed list, the user's communications device might directly provide the selected contact's master credentials. But when this is not possible, the ID cross-reference table is used to determine the selected contact's master credentials.

In step S610, the IP telephony service provider uses the selected contact's master credentials to determine the device registration data (such an IP address) assigned to one or more of the selected contact's communications devices. This information is then used to ring all of the devices which are associated with the selected contact's master credentials. Alternatively routing instructions might specify which of the devices to ring.

In step S612, the IP telephony service provider establishes an IP telephone call between the user's communications device and one of the selected contact's devices. Later, in step S614, when one of the parties terminates the session, the call would end.

In alternate embodiments, the IP telephony service might initiate an outgoing call that is routed through the PSTN or a cellular telephone network to reach a telephony device owned by the selected contact. In this instance, there would be no need for the user to have knowledge of the selected contact's telephone number. Instead, this information could be retrieved from the ID cross-reference table.

Alternatively, if the user chooses to establish an instant messaging session, the method proceeds to step S616. In this step, the IP telephony service provider still obtains the selected contact's master credentials, possibly based on a unique identifier assigned to the selected contact by a social networking site. In step S618, the system obtains the device registration data for at least one of the selected contact's communications devices, and then establishes an instant messaging session with that device.

In step S620, instant messages are passed between the user's communications device and the selected contact's device. Eventually, one or both parties terminates the instant messaging session in step S622.

When a communications device receives an incoming telephone call from the communications service, the incoming information may include the master credentials of the party initiating the call. In that instance, the receiving communications device could query the IP telephony service provider to obtain the name and possibly other identifying information about the calling party. This could include one or more images associated with the calling party. And this information could be displayed to the called party before the called party answers the call.

Alternatively, the incoming information might instead or in addition identify the calling party via a unique identifier assigned by a social networking site. In this instance, the receiving communications device may be able to query the social networking site to obtain information about the calling party, including one or more images associated with the calling party. Here again, this information could be presented to the called party before the call is answered.

The same sort of incoming information could be used by the receiving device when a user attempts to establish an instant messaging session with another party.

In some embodiments, the software used to facilitate communications between registered users could be configurable by the user to tailor the user experience. For instance, the user could choose to have his communications device display only contacts from certain communities. For instance, the user might configure the software so that when he wishes to contact another user, only contact lists from selected communities are presented as options.

Likewise a user might be able to configure his software to allow parties from only certain communities to contact the user via the service. In other words, the user might be able to block people who have the user as a contact on a certain social networking site from reaching the user via the communications service.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of establishing a communications channel between a first user and a second user, comprising:
obtaining contact information from a third party communication system with one or more processors;
creating, via the obtained contact information, a contact cross-reference database for use by a first communications system;
receiving, from a first user, a request to establish a communications link between the first user and a second user;
determining a non-publically switched telephony network (PSTN) convention identifier of a telephony device associated with the second user using information in the contact cross-reference database; and
establishing a communications channel between the first user and the second user via the first communications system using the determined identifier.

2. The method of claim 1, wherein the contact information obtained from the third party communication system includes contact information relating to the second user.

3. The method of claim 1, wherein the contact information obtained from the third party communication system is obtained from a contact list maintained for the first user on the third party communication system.

4. The method of claim 1, wherein the third party communication system is a social networking system.

5. The method of claim 1, wherein the receiving step comprises:
presenting the first user with a list of contacts; and
receiving an indication from the first user regarding which of the contacts the first user would like to contact.

6. The method of claim 5, wherein the presenting step comprises presenting the user with a list of contacts that includes only contacts that are listed in a contact list maintained for the first user on the third party communication system.

7. The method of claim 5, wherein the presenting step comprises presenting the user with a plurality of lists of contacts, wherein a first of the plurality of lists of contacts includes only contacts that are listed in a contact list maintained for the first user on the third party communication system, and wherein a second of the plurality of contact lists includes only contacts that are maintained in a contact list stored on a telephony device associated with the first user.

8. The method of claim 5, wherein the presenting step comprises presenting the first user with a list of contacts that includes images associated with contacts that were obtained from the third party communication system during the obtaining step.

9. The method of claim 1, wherein the determining step comprises:
causing a push notification service to communicate with a telephony device associated with the second user to cause the telephony device to obtain an Internet Protocol (IP) address; and
obtaining the IP address assigned to the telephony device associated with the second user from the push notification service.

10. The method of claim 1, wherein the establishing step comprises establishing a telephone call between a telephony device associated with the first user and a telephony device associated with the second user.

11. The method of claim 1, wherein the establishing step comprises causing at least one of a text message, an SMS message, an MMS message and a video message to be delivered to a telephony device associated with the second user.

12. The method of claim 1, wherein the receiving step is performed by an application running on a mobile telephony device associated with the first user.

13. A non-transitory storage medium storing computer software which, when installed on a mobile computing device, causes the mobile computing device to perform a method comprising:
causing a first communications system to obtain contact information stored on a third party communications system and to store the obtained contact information in a contact cross-reference database;
receiving, from a first user, a request to establish a communications link between the first user and a second user;
determining a non-publically switched telephony network (PSTN) convention identifier of a telephony device associated with the second user using information in the cross-reference database; and
causing a communications channel to be established between the first user and the second user using the determined identifier.

14. The non-transitory storage medium of claim 13, wherein the software also causes the mobile computing device to perform the step of causing a first communications system to obtain contact information stored on a third party communications system and to store the obtained information in a contact cross-reference database such that it includes the sub-steps of:
obtaining, from the first user, credentials that allow the first user to access the third party communication system;
causing the first communication system to access the third party communication system using the first user's credentials to obtain contact information stored on the third party communication system for the first user; and
causing the contact information obtained from the third party communication system to be stored in the contact cross-reference database.

15. The non-transitory storage medium of claim 13, wherein the software also causes the mobile computing device to perform the receiving step such that the receiving step comprises the sub-steps of:
presenting the first user with a list of contacts on a display screen of the mobile computing device; and
receiving an indication from the first user regarding which of the contacts the first user would like to contact.

16. The non-transitory storage medium of claim 13, wherein the software also causes the mobile computing device to perform the determining step such that it includes the sub-steps of:
causing a push notification service to communicate with a telephony device associated with the second user to cause the telephony device to obtain an Internet Protocol (IP) address; and
obtaining the IP address of the telephony device associated with the second user from the push notification service, the IP address comprising the non-publically switched telephony network (PSTN) convention identifier.

17. A system for establishing a communications channel between a first user and a second user, comprising:
means for obtaining contact information from a third party communication system with a processor of a first communications system;
means for storing the obtained contact information in a contact cross-reference database maintained by the first communications system;
means for receiving, from a first user, a request to establish a communications link between the first user and a second user;
means for determining a non-publically switched telephony network (PSTN) convention identifier of a telephony device associated with the second user using information in the contact cross-reference database; and
means for establishing a communications channel between the first user and the second user via the first communications system using the determined identifier.
